(19) United States
(12) Patent Application Publication
(10) Pub. No.: US 2023/0155464 A1
(43) Pub. Date: May 18, 2023

(54) COIL INSERTION GUIDE DEVICE

(71) Applicant: HONDA MOTOR CO., LTD., Tokyo (JP)

(72) Inventors: Norihiko HIKIMA, Tokyo (JP); Yasuto OHASHI, Tokyo (JP); Shoma OKUBO, Tokyo (JP)

(21) Appl. No.: 18/054,544

(22) Filed: Nov. 11, 2022

(30) Foreign Application Priority Data
Nov. 16, 2021 (JP) 2021-186271

(51) Int. Cl. H02K 15/085; B21F 3/00

(52) U.S. Cl. CPC H02K 15/085; B21F 3/00

(57) ABSTRACT

A coil insertion guide device includes a plurality of guide portions arranged over each of axially opposite end faces of a stator core including insulating members in slots, the guide portions being configured to guide movement of a strip-shaped coil insertable into the slots along a radial direction of the stator core, the strip-shaped coil includes a plurality of straight portions insertable into the slots and a plurality of coil end portions each connecting adjacent straight portions to each other among the plurality of straight portions, and in each of the guide portions, a shoulder portion that comes into contact with the coil end portion of the strip-shaped coil has a convex curved surface that is continuous from a top to a maximum width portion.

This application is based on and claims the benefit of priority from Japanese Patent Application No. 2021-186271, filed on 16 Nov. 2021, the content of which is incorporated herein by reference.

### BACKGROUND OF THE INVENTION

### Field of the Invention

The present invention relates to a coil insertion guide device.

### Related Art

Conventionally, there is known a technique for guiding a strip-shaped coil wound in a substantially cylindrical shape using a spacer extending in a radial direction, in order to suppress deformation of a bent portion of a coil end portion when the coil is inserted into slots from inside of a stator core (see, for example, Japanese Unexamined Patent Application, Publication No. 2017-112749).
Patent Document 1: Japanese Unexamined Patent Application, Publication No. 2017-112749

### SUMMARY OF THE INVENTION

According to the above technique of Japanese Unexamined Patent. Application, Publication No. 2017-112749, the spacer for guiding the insertion of the strip-shaped coil is a component of the stator and hence cannot be reused. Therefore, it is necessary to provide the spacer for each stator.

In addition, guiding the strip-shaped coil with the spacer has the following disadvantages. As shown in FIG. 17, a strip-shaped coil C is generally shaped by way of sequential bending to form a plurality of straight portions C1 that are parallel to each other and coil end portions C2 that alternately connect end portions of the adjacent straight portions C1 and C1 to each other and have a chevron-like shape. As the strip-shaped coil C moves radially outward in the slots, the circumference of the strip-shaped coil C increases, whereby the coil is deformed so that a pitch Pt of the straight portions C1 increases and the coil end portions C2 expands. Therefore, as shown with white arrows in FIG. 17, a reaction force F to close the coil end portion C2 acts on the strip-shaped coil C in the vicinity of each connecting portion between the straight portion C1 and the coil end portion C2.

FIG. 18 schematically shows a behavior of the straight portion C1 in a slot ST when the reaction force F acts on the coil end portion C2 of the strip-shaped coil C. The coil end portion C2 is pulled to be inclined in a circumferential direction as a diameter increases. Consequently, a contact region with the spacer indicated by a triangle in FIG. 18 serves as a fulcrum P1, and a point at which the reaction force F acts serves as a point of effort, whereby the principle of leverage works. As a result, the straight portion C1 in the slot ST is inclined and comes into contact with an inner wall surface of the slot ST on a side opposite to the contact region, and the straight portion C1 is deformed while the contact region serving as a point of load P2. Since the reaction force F acts in opposite directions at both end portions of the straight portion C1, the straight portion C1 in the slot ST comes into contact with opposed inner wall surfaces of the slot ST on each of opposite sides of a stator core in an axial direction. A load continues to be applied locally to the point of load P2 until the insertion of the strip-shaped coil C into the slots ST is completed, and hence the straight portion C1 in the slot ST is deformed into a substantially S shape. The deformed straight portion C1 bites or breaks insulating paper in the slot ST, and reduces workability in mounting the strip-shaped coil C in the slots ST. However, Japanese Unexamined Patent Application, Publication No. 2017-112749 does not disclose any specific measures for suppressing the deformation of the straight portion in the slot.

An object of the present invention is to provide a coil insertion guide device capable of suppressing deformation of a straight portion of a strip-shaped coil to be inserted into slots of a stator core and capable of improving workability in mounting the coil in the slot.

A first aspect of the present invention is directed to a coil insertion guide device (for example, a coil insertion guide device 1 described later) including a plurality of guide portions (for example, guide portions 331 described later) arranged over each of end faces (for example, end faces 2a described later) of a stator core (for example, a stator core 2 described later) that are opposite in an axial direction (for example, a Z-direction described later), the stator core including insulating members (for example, insulating paper 24 described later) in slots (for example, slots 22 described later), the guide portions being configured to guide movement of a strip-shaped coil (for example, a strip-shaped coil 100 described later) that is insertable into the slots along a radial direction (for example, a Y-direction described later) of the stator core. The strip-shaped coil includes a plurality of straight portions (for example, straight portions 102 described later) insertable into the slots and a plurality of coil end portions (for example, coil end portions 103 described later) each connecting adjacent straight portions to each other among the plurality of straight portions. In each of the guide portions, a shoulder portion (for example, a shoulder portion 331b described later) that comes into contact with the coil end portion of the strip-shaped coil has a convex curved surface that is continuous from a top (for example, a top 331c described later) to a maximum width portion (for example, a maximum width portion 331d described later).

A second aspect is an embodiment of the first aspect. In the coil insertion guide device according to the second aspect, it is preferable that each of the guide portions has, in a portion facing the end face of the stator core, a regulating groove portion that accommodates and regulates the insulating member protruding from the end, and a height of the regulating groove portion is defined as “insulating member regulating height”, a radius of a curved surface of a corner portion formed between the regulating groove portion and the maximum width portion of the guide portion adjacent to the regulating groove portion is defined as “coil contact surface escape R”, a height, from the end face of the stator core, of a region in which the guide portion first comes into contact with the strip-shaped coil is defined as “coil initial contact position”, and a height, from the end face of the stator core, of a boundary between the straight portion and the coil end portion of the strip-shaped coil is defined as “coil R start point”,

the guide portion satisfies:
condition A: “insulating member regulating height”+“coil contact surface escape R”≤“coil initial contact position”≤“coil R start point”.

A third aspect is an embodiment of the second aspect. In the coil insertion guide device according to the third aspect, it is preferable that in the condition A, a bend radius of a root portion of the coil end portion is defined as “coil end shoulder R”, and “coil R start point” 5 “coil end shoulder R”.

A fourth aspect is an embodiment of any one of the first to third aspects. In the coil insertion guide device according to the fourth aspect, it is preferable that a width of the strip-shaped coil is defined as “coil width”, a clearance between adjacent ones of the guide portions is defined as “guide CL”, and

the guide portion satisfies:
condition B: “coil width”≤“guide CL”.

A fifth aspect is an embodiment of any one of the first to fourth aspects. In the coil insertion guide device according to the fifth aspect, it is preferable that a radius of a curved surface of the shoulder portion of the guide portion is defined as “guide shoulder R”, a bend radius of a root portion of the coil end portion is defined as “coil end shoulder R”, and

the guide portion satisfies:
condition C: “guide shoulder R”≤“coil end shoulder R”.

A sixth aspect is an embodiment of any one of the first to fifth aspects. It is preferable that the coil insertion guide device according to the sixth aspect further includes a coil winding jig (for example, a coil winding jig 4 described later) including comb teeth (for example, comb teeth 42 described later) around which the strip-shaped coil is wound and held before insertion into the slot. Preferably, a radius of a curved surface of a shoulder portion of the comb tooth that comes into contact with the strip-shaped coil is defined as “comb tooth shoulder R”, and

the guide portion satisfies:
condition D: “guide shoulder R”≤“comb tooth shoulder R”.

According to the first aspect, each coil end portion is gradually deformed to be inclined along the curved surface of the shoulder portion of the guide portion as the strip-shaped coil moves in the slots, whereby a position of a contact portion between the strip-shaped coil and the shoulder portion of the guide portion shifts. Therefore, when a point at which a reaction force acts on the coil end portion serves as a point of effort and the contact portion serves as a fulcrum, a position of a point of load at which the straight portion of the strip-shaped coil abuts on an inner wall surface of the slot also shifts. Consequently, local application of a load to the straight portion is avoided, and substantially S-shaped deformation of the straight portion is suppressed. As a result, workability in mounting the strip-shaped coil in the slots improves.

According to the second aspect, setting “coil initial contact position” to be equal to or more than “insulating member regulating height.”+“coil contact surface escape R” results in a decrease in a distance between the fulcrum and the point of effort, and makes it unlikely for the straight portion is to be inclined. Setting “coil R start point” to be equal to or more than “coil initial contact position” further reduces the inclination of the straight portion with a contact portion as the fulcrum. Thus, the guide portion can more effectively suppress the substantially S-shaped deformation of the straight portion.

According to the third aspect, the contact height of the guide portion with the strip-shaped coil can be kept low, and an effect of an excessive length of the straight portion on a motor performance can be reduced.

According to the fourth aspect, damage to a coating of the strip-shaped coil can be reduced while reducing the inclination of the straight portion.

According to the fifth aspect, when the strip-shaped coil comes into contact with the guide portion and the strip-shaped coil starts to be plastically deformed, the position of the contact portion serving as the fulcrum is likely to gradually move in a direction away from the end face of the stator core. Thus, a situation is more effectively prevented or reduced in which the straight portion is deformed into the substantially S-shape due to a local increase in load in the slot that can be caused by shifting of the position of the point of load.

According to the sixth aspect, it is possible to reduce the inclination of the straight portions of the strip-shaped coil after the strip-shaped coil comes into contact with the shoulder portions of the guide portions from the comb teeth and transfers from the comb teeth to the guide portions.

### BRIEF DESCRIPTION OF THE DRAWINGS

FIG. 1 is a perspective view showing a coil insertion guide device to which a stator core is mounted;

FIG. 2 is a perspective view showing an insulating member mounted in a slot of the stator core;

FIG. 3 is a plan view showing a part of the coil insertion guide device to which a coil winding jig and the stator core are mounted;

FIG. 4 is a side view of a guide member;

FIG. 5 is a cross-sectional view along the A-A line in FIG. 4;

FIG. 6 is a perspective view showing the coil winding jig;

FIG. 7 is a front view showing a strip-shaped coil;

FIG. 8 is a perspective view showing a behavior in inserting a coil expander inside the strip-shaped coil;

FIG. 9 is a plan view showing a part of the coil insertion guide device before the strip-shaped coil is inserted with a guide portion being disposed at the guide position;

FIG. 10 is a plan view showing a part of the coil insertion guide device after the strip-shaped coil is inserted with the guide portion being disposed at the guide position;

FIG. 11 is an explanatory view of a relation between the guide portion and the strip-shaped coil;

FIG. 12 is an explanatory view of a force acting on the strip-shaped coil during insertion into the slot;

FIG. 13 is an explanatory view of respective regions of the guide portion and strip-shaped coil;

FIG. 14 is an explanatory view of a coil end portion shoulder R;

FIG. 15 is an explanatory view of a comb tooth shoulder R;

FIG. 16 is a perspective view showing appearance of a stator;

FIG. 17 is an explanatory view of a force acting on the coil during the insertion into the slot; and

FIG. 18 is an explanatory view of a force acting on the strip-shaped coil during the coil insertion.

### DETAILED DESCRIPTION OF THE INVENTION

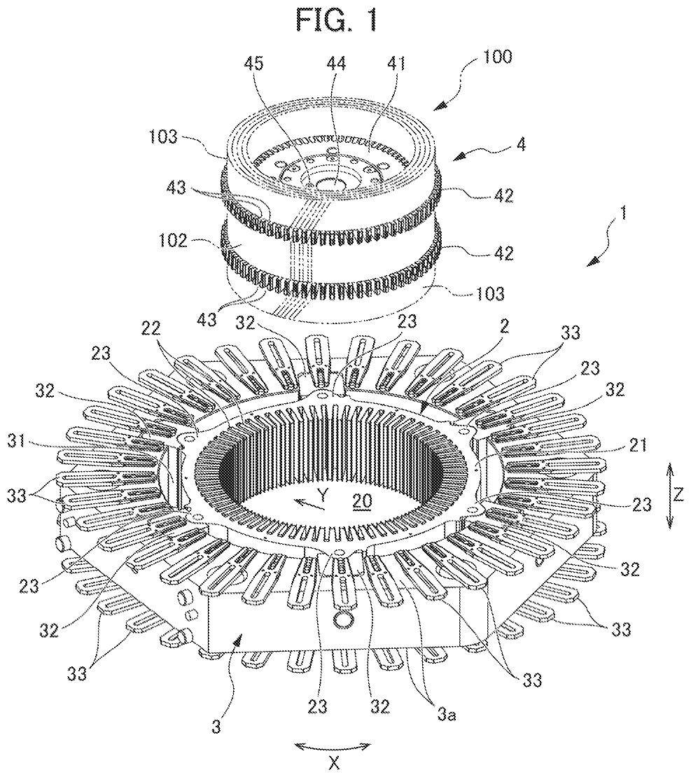

Embodiments of the present invention will be described in detail with reference to the drawings. A coil insertion guide device 1 shown in FIG. 1 includes a stator: core 2, a positioning jig 3 that positions and fixes the stator core 2 in an inside thereof, and a coil winding jig 4 insertable inside the stator core 2 and having a strip-shaped coil 100 wound in an annular shape therearound.

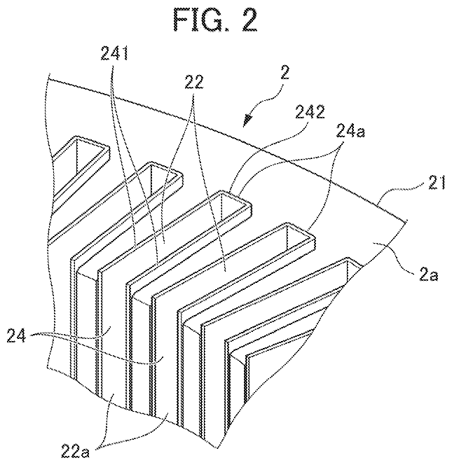

The stator core 2 includes an annular portion 21 including a laminate of a plurality of thin core plates. The stator core 2 has a through hole 20 that penetrates a center of the annular portion 21 in an axial direction. As shown in FIG. 2, the stator core 2 has a plurality of slots 22 that penetrate the stator core 2 in the axial direction. The slots 22 are arranged radially at regular intervals along a circumferential direction of the annular portion 21 and have openings 22a that open toward the through hole 20 provided radially inside the annular portion 21. The stator core 2 of the present embodiment has seventy-two slots 22. The annular portion 21 of the stator core 2 has, on its outer periphery, six ear portions 23 that protrude at regular intervals. For the stator core 2 and the positioning jig 3, as shown in FIG. 1, an X-direction in which the slots 22 are arranged corresponds to the circumferential direction, a Y-direction along the radial direction from a center of the through hole 20 corresponds to the radial direction, and a Z-direction corresponds to the axial direction.

The positioning jig 3 has a hexagonal prism shape with an axial dimension substantially equal to an axial dimension of the stator core 2 and has, at a center, a stator core insertion hole 31 into which the stator core 2 can be inserted and disposed. The positioning jig 3 has core pressing blocks 32 that respectively hold the six ear portions 23 arranged on an outer periphery of the stator core 2, thereby fixing the stator core 2 in the stator core insertion hole 31 at a predetermined position and in a predetermined posture.

As shown in FIG. 2, in each slot 22 of the stator core 2, an insulating paper 24 that is an insulating member is mounted in advance. The insulating paper 24 is folded into a substantially U-shape to follow an inner surface of the slot 22 having a substantially U-shape when the stator core 2 is viewed in the axial direction. Specifically, the insulating paper 24 includes a pair of radial portions 241 and 241 along an inner wall surface of the slot 22 extending in the radial direction of the stator core 2, and a circumferential portion 242 that is a back portion connecting radially outer ends of the radial portions 241 and 241 to each other along the circumferential direction of the stator core 2.

The insulating paper 24 mounted in the slot 22 has a cuff portion 24a. The cuff portion 24a is a portion in which the radial portions 241 and 241 and the circumferential portion 242 of the insulating paper 24 are extended in the axial direction beyond the stator core 2 to protrude from the slot 22 and protrude outward from the end face 2a of the stator core 2 in the axial direction. While FIG. 2 shows only one cuff portion 24a of the insulating paper 24 that protrudes from one end face 2a of the stator core 2, the cuff portion 24a protrudes from each of opposite end faces 2a and 2a of the stator core 2 in the axial direction.

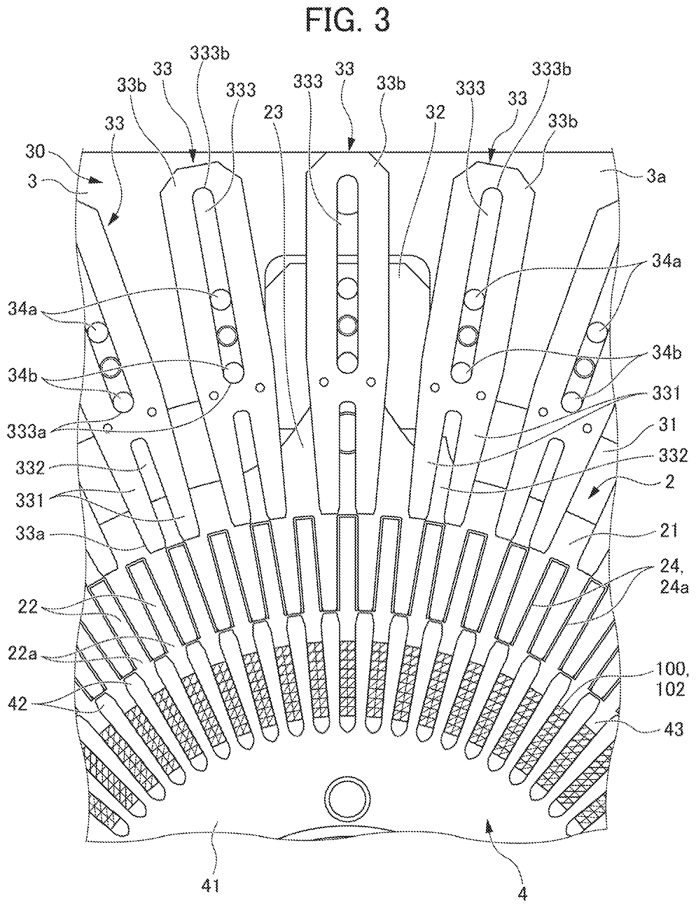

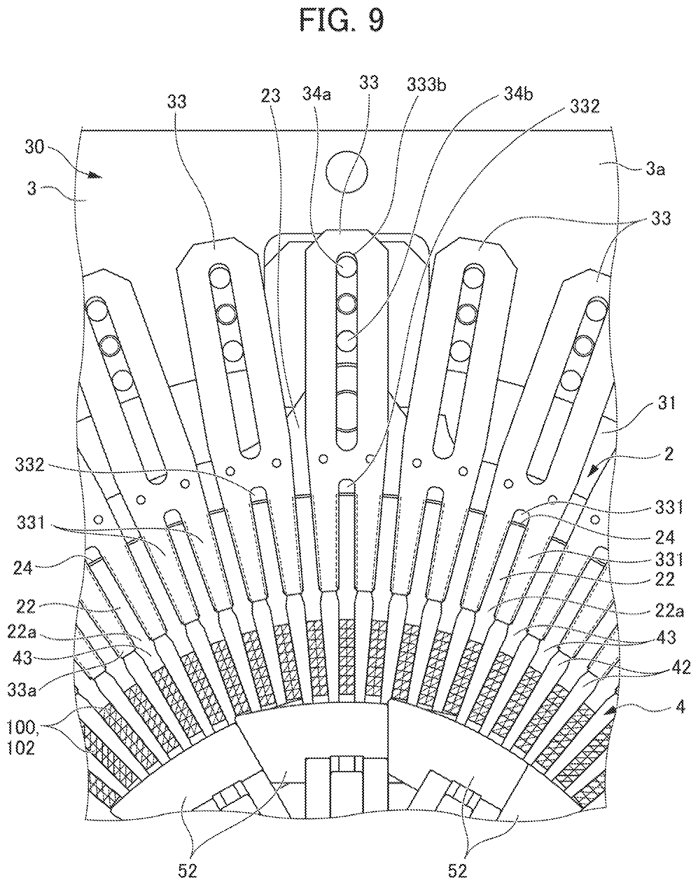

As shown in FIGS. 1 and 3, a plurality of cuff guides 33 are attached to each of axially opposite end faces 3a and 3a of the positioning jig 3, to which the stator core 2 is fixed in advance, so that the cuff guides are arranged radially at regular intervals along the circumferential direction. Each of the cuff guides 33 includes guide portions 331 that guide movement of the strip-shaped coil 100 to be described later when it is in inserted into the slot 22 of the stator core 2. The cuff guide 33 is capable of advancing and retracting along the radial direction of the stator core 2 when driven by an actuator such as an unshown cylinder. The cuff guide 33 is positioned at a guide position to guide the strip-shaped coil 100 by being moved when moving inward in the radial direction of the stator core 2 (see FIG. 9).

The cuff guide 33 has a thin plate shape that is long in the radial direction of the stator core 2. As shown in FIGS. 3, 4 and 5, each cuff guide 33 has a pair of guide portions 331 and 331 that are provided adjacent to an inner end 33a, protrude inward in the radial direction, and guide the movement of the strip-shaped coil 100 to be described later. The pair of guide portions 331 and 331 are formed by cutting out a portion near the inner end 33a of the cuff guide 33 in a U-shape along a length direction of the cuff guide 33. Between the pair of guide portions 331 and 331, a groove portion 332 is formed that opens inward and that receives the strip-shaped coil 100. A clearance between the pair of guide portions 331 and 331 (i.e., a width of the groove portion 332) is substantially equal to a width of the slot 22 along the circumferential direction of the stator core 2. A length D of each of the guide portions 331 (i.e., a groove depth of the groove portion 332) is equal to or greater than a depth of the slot 22 along the radial direction of the stator core 2. The cuff guide 33 has a long hole 333 that regulates a radial movement range of the cuff guide 33, and that is formed toward an outer end 33b in comparison with the guide portions 331 and 331.

The coil insertion guide device 1 of the present embodiment includes thirty-six cuff guides 33 corresponding to every other slot 22 of the stator core 2, per end face 3a of the positioning jig 3. In a state where each cuff guide 33 is positioned at the guide position, the clearance between the guide portions 331 and 331 of the adjacent cuff guides 33 and 33 is also set to be substantially equal to the width of the slot 22 and the width of the groove portion 332 along the circumferential direction of the stator core 2. Therefore, the clearance between the guide portions 331 and 331 of the adjacent cuff guides 33 and 33 is configured to receive the strip-shaped coil 100 and to guide insertion into the slot 22 in the same manner as the groove portion 332.

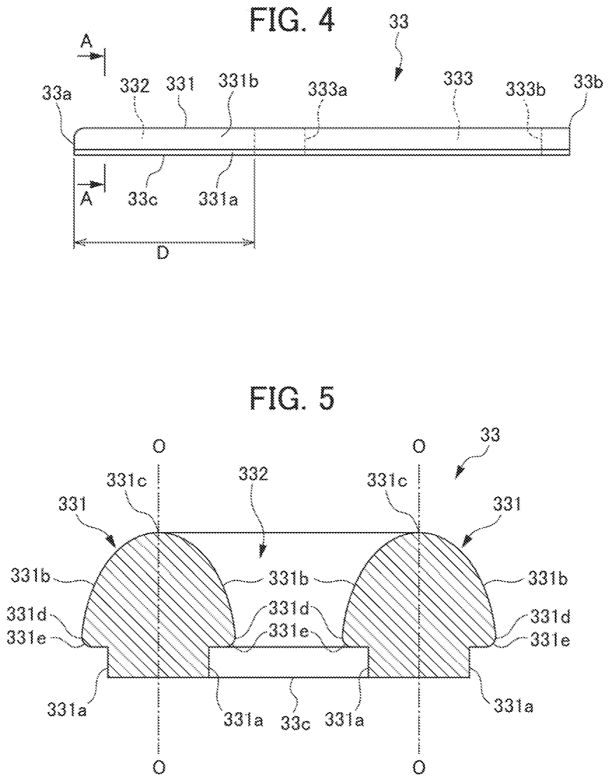

As shown in FIGS. 4 and 5, the guide portion 331 has a cuff portion-regulating groove portion 331a that accommodates and regulates the cuff portion 24a of the insulating paper 24 disposed on opposite sides of the guide portion 331 at the guide position. The cuff portion-regulating groove portion 331a is formed at each of both side edges of the guide portion 331 by narrowing a width of a portion of the cuff guide 33 adjacent to a bottom surface 33c (surface facing the end face 2a of the stator core 2). The cuff portion-regulating groove portion 331a has a height with which the cuff portion 24a of the insulating paper 24 protruding from the end face 2a of the stator core 2 can be accommodated. The cuff portion-regulating groove portions 331a and 331a extend over at least the entire length of the guide portion 331 of the cuff guide 33.

As shown in FIG. 5, a portion of the guide portion 331 above the cuff portion-regulating groove portions 331a and 331a (portion away from the bottom surface 33c of the cuff guide 33) is wide and has a substantially hemispherical cross-sectional shape. The surface of the guide portion 331 above the cuff portion-regulating groove portions 331a and 331a forms shoulder portions 331b and 331b that come into contact with a coil end portion 103 of the strip-shaped coil 100 to be described later and that guide movement of the strip-shaped coil 100.

As shown in FIG. 5, the shoulder portions 331b and 331b each have a cross-sectional shape symmetrical with respect to a centerline O that passes through a center of the guide portion 331 along the axial direction of the stator core 2. Specifically, the shoulder portion 331b, 331b is formed by a convex curved surface that is continuous from the top 331c on the centerline O to the maximum width portion 331d, 331d immediately above the cuff portion-regulating groove portion 331a, 331a. Corner portion 331e, 331e each located between an associated one of the cuff portion-regulating groove portions 331a, 331a and an associated one of the maximum width portions 331d, 331d forms a rounded curved surface. The guide portions 331 have the same thickness along the length direction (the radial direction of the stator core 2) and have the same cross-sectional shape. A relationship between the guide portion 331 and the strip-shaped coil 100 will be described later in more detail.

As shown in FIG. 3, on each of the opposite end faces 3a and 3a of the positioning jig 3, an inner diameter-side regulation pin 34a and an outer diameter-side regulation pin 34b are provided in a pair in correspondence with each of the cuff guides 33. The inner diameter-side regulation pin 34a abuts on an inner end portion 333a of the long hole 333 when the cuff guide 33 moves outward in the radial direction of the positioning jig 3, thereby positioning the cuff guide 33 at a non-guided position that is outermost in the radial direction, as shown in FIG. 3. In the non-guided position, the inner end 33a of the cuff guide 33 is positioned outside the stator core insertion hole 31 in the radial direction. The outer diameter-side regulation pin 34b abuts on an outer end portion 333b of the long hole 333 when the cuff guide 33 moves inward in the radial direction of the positioning jig 3, thereby positioning the cuff guide 33 at a guide position that is innermost in the radial direction. At this time, the inner end 33a of the cuff guides 33 is positioned outside the coil winding jig 4 in the radial direction (see FIG. 9).

Since the stator core 2 is inserted into the stator core insertion hole 31 of the positioning jig 3 from either one side in the axial direction, the cuff guides 33 disposed on the side opposite to the side from which the stator core 2 is inserted may be disposed so that the inner ends 33a interfere with the annular portion 21 of the stator core 2 in a state where the outer diameter-side regulation pins 34b abut on the inner end portions 333a of the long holes 333 as shown in FIG. 3. However, the inner diameter-side regulation pin 34a and the outer diameter-side regulation pin 34b may be configured to selectively protrude and retreat with respect to the surface of the positioning jig 3, by an advancing/retracting mechanism (not shown) including an actuator such as a cylinder provided inside the positioning jig 3. Thereby, in the case where the cuff guides 33 are arranged as shown in FIG. 3, the inner diameter-side regulation pins 34a and the outer diameter-side regulation pins 34b are retracted below the surface of the positioning jig 3 as needed, thereby allowing the cuff guide 33 to move further outward in the radial direction, so that the cuff guide 33 can be retracted completely from the annular portion 21 of the stator core 2, as shown in FIG. 1.

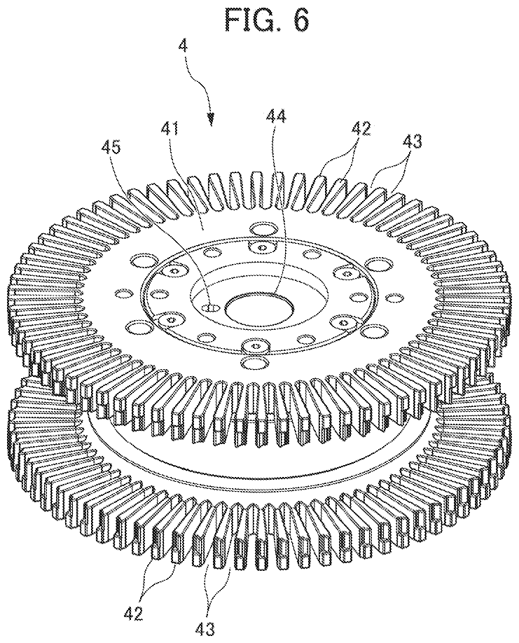

As shown in FIG. 6, the coil winding jig 4 includes a substantially cylindrical jig body 41, a plurality of comb teeth 42 that radially protrude from an outer periphery of the jig body 41, a plurality of coil mounting grooves 43 formed between the comb teeth 42 adjacent to each other in the circumferential direction, and a shaft hole 44 that opens at a center of the jig body 41. The comb teeth 42 and the coil mounting grooves 43 are provided on each of axially opposite end portions of the jig body 41. A distance between the comb teeth 42 and the comb teeth 42 on each of the axially opposite end portions of the jig body 41 is substantially equal to a distance between the guide portions 331 and 331 arranged over each of the opposite end faces 2a and 2a of the stator core 2. Phases of the comb teeth 42 and the coil mounting grooves 43 on one of the opposite end portions of the jig body 41 are aligned in the axial direction with those on the other of the opposite end portions. The number of the coil mounting grooves 43 arranged in the circumferential direction of the jig body 41 matches the number of the slots 22 provided in the stator core 2. The coil winding jig 4 is formed so that its outer diameter defined by the position of tips of the comb teeth 42 is smaller than the diameter of the through hole 20 of the stator core 2, whereby the jig can be inserted into the annular portion 21 of the stator core 2.

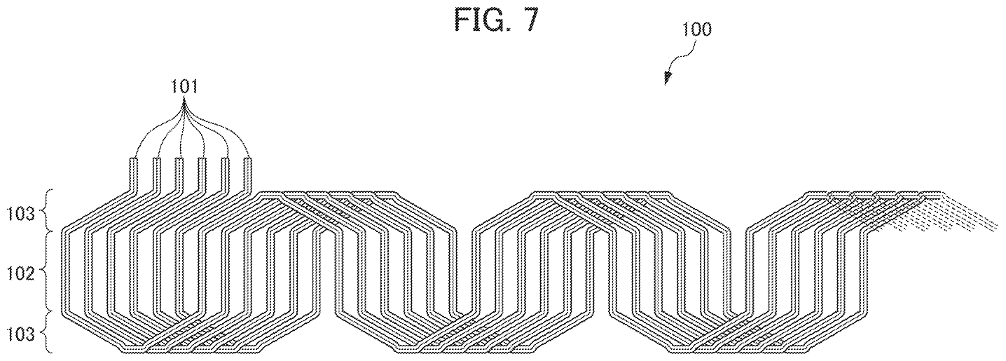

The strip-shaped coil 100 is wound in an annular shape around the coil winding jig 4. As shown in FIG. 7, the strip-shaped coil 100 is a continuous wave winding coil having a shape of a long strip and made of a flat wire 101 of copper, aluminum or the like with a substantially rectangular cross-sectional shape. Setting the continuous wave winding coil to the stator core 2 does not require a common dominant technique for forming a plurality of coil segments and welding ends of the coil segments after insertion in slots, thereby eliminating, for example, the need to use a high-purity copper material for the coil in order to cope with thermal processing of welded portions. Therefore, it is also possible to use a recycled copper material containing impurities, and to contribute to achieving of recycling of resources. In addition, the wave winding coil does not have to be welded, so that a weight of the coil can be reduced, and a weight of a rotary electric machine including this coil can be reduced. When the rotary electric machine is mounted in a hybrid car, the vehicle weight is reduced, enabling reduction in carbon dioxide emissions can be reduced, and reduction of adverse effects on global environment.

The strip-shaped coil 100 includes a plurality of straight portions 102 and a plurality of coil end portions 103. Each of the straight portions 102 is to be inserted into the slot 22 of the stator core 2, and the straight portions extend substantially linearly and are arranged in parallel at regular intervals. The coil end portions 103 are each arranged at a position closer to a side end of the strip-shaped coil 100 than the straight portions 102, and alternately connect end portions of adjacent straight portions 102 to each other and the opposite end portions of the adjacent straight portions 102 to each other in a substantially triangular chevron-like shape. Each of the coil end portions 103 is a portion disposed to protrude from the slot 22 in the axial direction of the stator core 2 when the strip-shaped coil 100 is mounted in the slots 22 of the stator core 2. The strip-shaped coil 100 of the present embodiment has the shape of a long strip and is formed by bundling six flat wires 101 that have been bent to have the plurality of straight portions 102 and the plurality of coil end portions 103 so that the straight portions 102 are arranged in parallel at regular intervals.

The coil winding jig 4 winds up the strip-shaped coil 100 multiple turns by sequentially inserting the straight portions 102 of the strip-shaped coil 100 into the coil mounting grooves 43 before the jig 4 is inserted inside the stator core 2. Thereby, as shown in FIG. 1, the coil winding jig 4 is prepared, which has the strip-shaped coil 100 wound therearound in an annular shape.

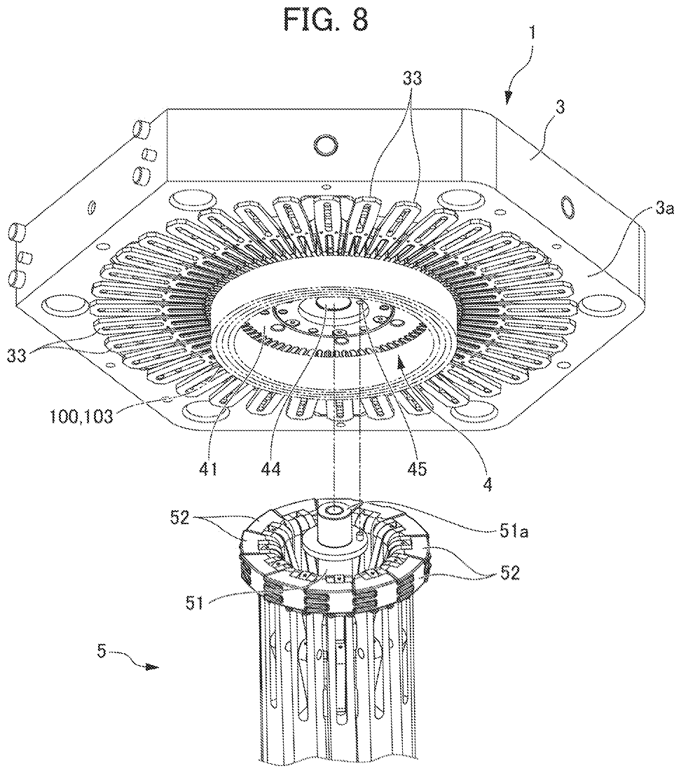

The strip-shaped coil 100 wound around the coil winding jig 4 is disposed inside the stator core 2, and then pushed and expanded from inside by a coil expander 5 shown in FIG. 8 to increase in diameter. While FIG. 8 shows only one coil expander 5, coil expanders 5 are arranged on axially opposite sides of the coil insertion guide device 1 and push and expand the coil end portions 103 of the strip-shaped coil 100 from the axially opposite sides.

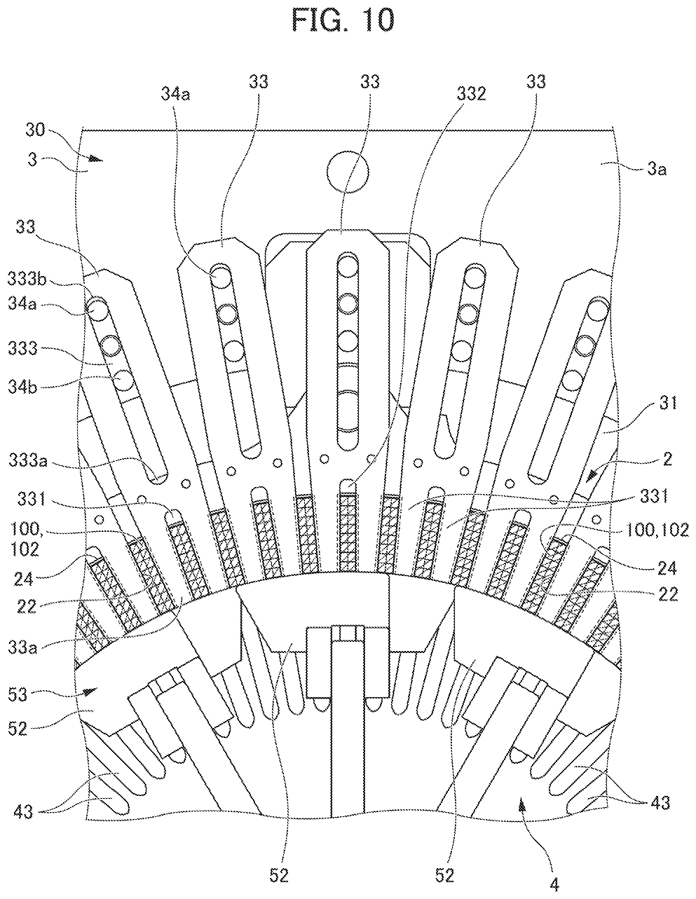

As shown in FIGS. 8 to 10, the coil expander 5 includes a spindle portion 51 and a plurality of coil pressing portions 52 provided on an outer periphery of an end portion of spindle portion 51. The plurality of coil pressing portions 52 are arranged in an annular shape along the outer periphery of the end portion of the coil expander 5 and are capable of increasing and reducing in diameter by moving in the radial direction by being driven by an actuator (not shown). As shown in FIGS. 8 and 9, an outer diameter defined by the coil pressing portions 52 with the reduced diameter is equal to or less than an inner diameter of the annular strip-shaped coil 100 wound around the coil winding jig 4. As shown in FIG. 10, an outer diameter defined by the coil pressing portions 52 with the increased diameter is larger than an outer diameter of the coil winding jig 4.

The coil expander 5 inserts the coil pressing portions 52 with the reduced diameter inside the coil end portions 103 of the annular strip-shaped coil 100 wound around the coil winding jig 4, and fits a tip portion 51a of the spindle portion 51 into the shaft hole 44 of the coil winding jig 4 so as to hold the coil winding jig 4. As shown in FIG. 10, when the coil pressing portion 52 inserted inside the strip-shaped coil 100 expands in diameter, the coil end portions 103 of the strip-shaped coil 100 are pressed outward, and the strip-shaped coil 100 expands in diameter. As a result, the straight portions 102 of the strip-shaped coil 100 move toward the inside of the insulating papers 24 in the slots 22 located radially outside, and then are inserted into the slots 22.

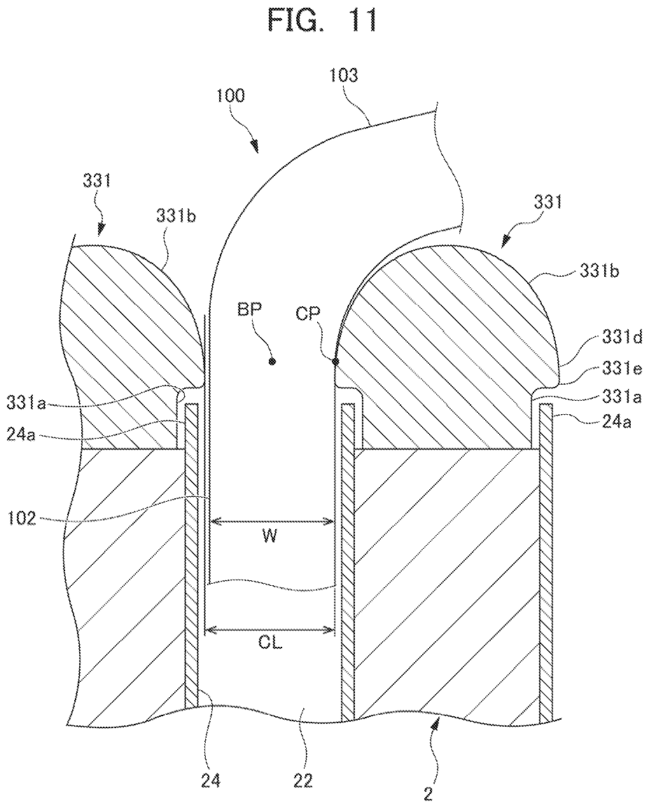

As shown in FIG. 11, when each of the straight portions 102 is inserted into the slot 22, a contact portion CP of the strip-shaped coil 100 first comes into contact with the shoulder portion 331b of the guide portion 331. The contact portion CP has about the same height as a coil end R-start point BP that is a boundary between the straight portion 102 and the coil end portion 103 and at which the coil end portion 103 starts to bend. Thereafter, the strip-shaped coil 100 is pushed by the coil pressing portions 52, and each coil end portion 103 moves toward the interior of the slot 22 inside the insulating paper 24 while being guided by the shoulder portion 331b of the guide portion 331. As the diameter of the strip-shaped coil 100 expands, a pitch of the straight portions 102 gradually increases, and the coil end portions 103 are expanded to open in the circumferential direction.

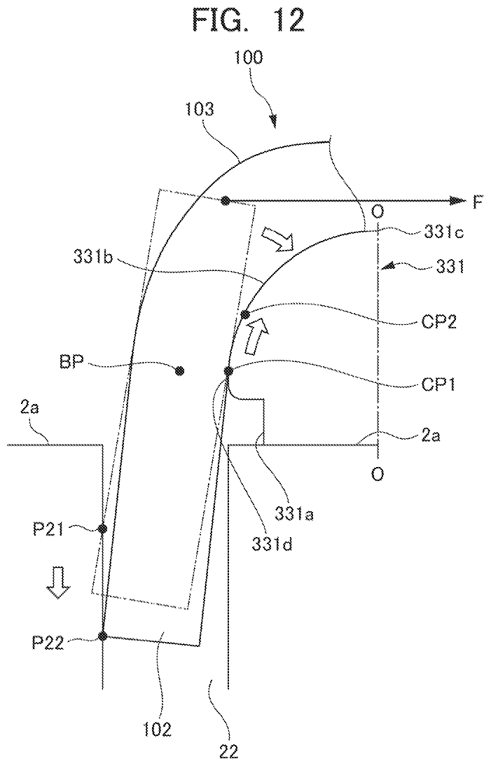

Here, the shoulder portion 331b of the guide portion 331 is constituted by the convex curved surface that is continuous from the top 331c on the centerline O to the maximum width portion 331d immediately above the cuff portion-regulating groove portion 331a, 331a, as shown in FIG. 5. Therefore, as shown in FIG. 12, following the strip-shaped coil 100 first coming into contact with the guide portion 331 at a contact portion CP1, as the strip-shaped coil 100 moves in the slot 22, the coil end portion 103 is gradually deformed to be inclined along the curved surface of the shoulder portion 331b of the guide portion 331. Accordingly, a contact region between the strip-shaped coil 100 and the guide portion 331 shifts from the first contact portion CP1 to a contact portion CP2 that is closer to the top 331c of the guide portion 331. Therefore, the principle of leverage works while a point at which a reaction force F acting on the coil end portion 103 serves as the point of effort and the contact portion CP serves as the fulcrum. The point of load at which the straight portion 102 abuts on the inner wall surface of the slot 22 also shifts from a point of load P21 at the time when the fulcrum corresponds to the first contact portion CP1, to a point of load P22, due to the fulcrum moving to the contact portion CP2. Consequently, a situation in which a load is locally applied to the straight portion 102 is avoided, making it unlikely for the straight portion 102 to be deformed into a substantially S shape. As a result, workability in mounting the strip-shaped coil 100 in the slots 22 is improved.

Here, it is desirable that the guide portions 331 of the coil insertion guide device 1 satisfy at least one selected from the following conditions A to D.

Condition A: “insulating member regulating height”+“coil contact surface escape R”≤“coil initial contact position”≤“coil R start point”

Condition B: “coil width”≤“guide CL”. Condition C: “guide shoulder R”≤“coil end shoulder R”
Condition D: “guide shoulder R”≤“comb tooth shoulder R”

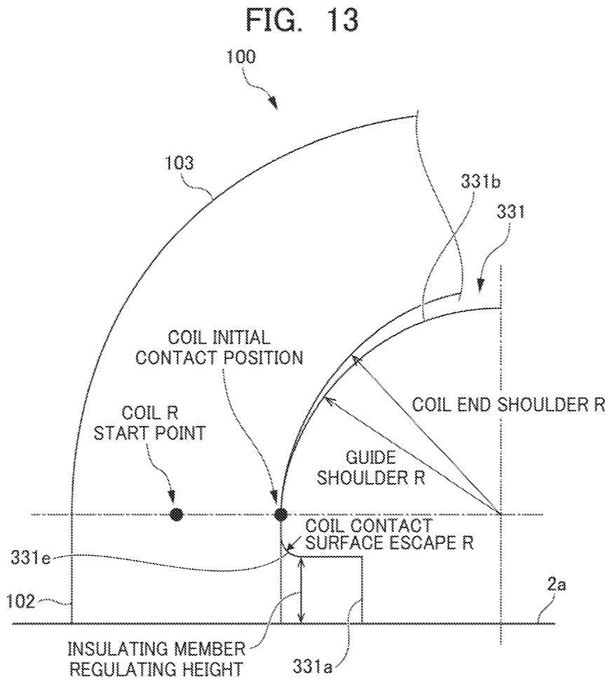

The above condition A will be described with reference to FIG. 13. The term “insulating member regulating height” indicates a height of the cuff portion-regulating groove portion 331a of the guide portion 331. The term “coil contact surface escape R” indicates a radius of a curved surface of the corner portion 331e immediately above the cuff portion-regulating groove portion 331a of the guide portion 331. The term “coil initial contact position” indicates a height, from the end face 2a of the stator core 2, of the contact portion CP in which the strip-shaped coil 100 first comes into contact with the guide portion 331. The term “coil R start point” indicates a height of the R start point BP of the coil end portion 103 from the end face 2a of the stator core 2. In the present embodiment, the coil initial contact position is set to the same height as the coil R start point. Setting “coil initial contact position” to be equal to or more than “insulating member regulating height”+“coil contact surface escape R” results in a decrease in a distance between the fulcrum and the point of effort, and makes it less likely for the straight portion 102 to be inclined. Setting “coil R start point” to be equal to or more than “coil initial contact position” further reduces the inclination of the straight portion 102 from the contact portion CP as the fulcrum. Therefore, by satisfying the above condition A, the guide portions 331 can further effectively suppress the substantially S-shaped deformation of the straight portion 102.

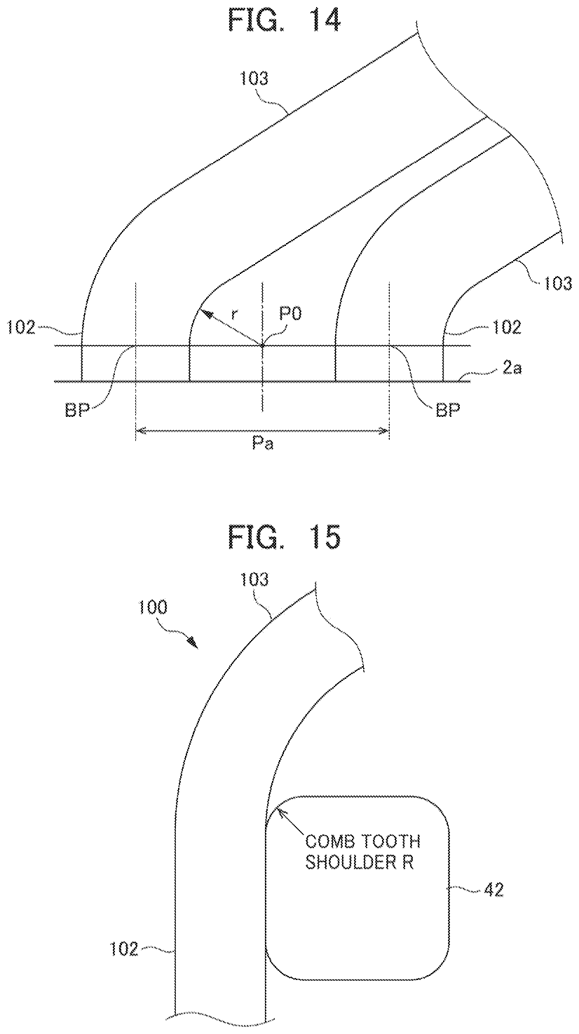

It is further desirable that “coil R start point” S “coil end shoulder R” in the above condition A. As shown in FIG. 13, “coil end shoulder R” indicates a bend radius of a root portion of the coil end portion 103. Specifically, as shown in FIG. 14, “coil end shoulder R” indicates a radius r centered at a position P0 at which a center of a pitch Pa of the adjacent straight portions 102 and 102 inserted into the adjacent slots 22 and 22 intersects with the height, from the end face 2a of the stator core 2, of the R start point BP at which the coil end portion 103 starts to bend. The radius r indicates a radius of a curved surface disposed inside in a bending direction of the coil end portion 103. Thereby, a contact height of the guide portion 331 with the strip-shaped coil 100 can be kept low, and an effect of an excessive length of the straight portion 102 on a motor performance can be reduced.

The above condition B will be described with reference to FIG. 11. The term “coil width” indicates a maximum width dimension W of the straight portion 102 of the strip-shaped coil 100. The term “guide CL” indicates a clearance CL between the adjacent guide portions 331 and 331. The clearance CL indicates a dimension between the maximum width portions 331d and 331d of the adjacent guide portions 331 and 331. It is advantageous that “guide CL” is narrow from the viewpoint of reducing the inclination of the straight portion 102, but there is concern that, when the strip-shaped coil 100 moves, a coating formed on the surface of the strip-shaped coil 100 is damaged. Setting “guide CL” to be equal to or greater than “coil width” makes it possible to reduce damage to the coating of the strip-shaped coil 100 while reducing the inclination of the straight portion 102.

The above condition C will be described with reference to FIG. 13. The term “guide shoulder R” indicates a radius of a curved surface of the shoulder portion 331b of the guide portion 331. As “guide shoulder R” increases, the position of the contact portion CP between the strip-shaped coil 100 and the guide portion 331 increases in height, and the inclination of the straight portion 102 decreases. When “guide shoulder R” is large, the contact surface with the strip-shaped coil 100 becomes larger, a contact surface pressure between the strip-shaped coil 100 and the guide portion 331 accordingly decreases, and damage to the strip-shaped coil 100 can be reduced. Setting “guide shoulder R” to be equal to or less than “coil end shoulder R” makes it likely for the position of the contact portion CP serving as the fulcrum to gradually move in a direction away from the end face 2a of the stator core 2 when the strip-shaped coil 100 comes into contact with the guide portion 331 and starts to be plastically deformed. Therefore, a situation is more effectively prevented or reduced in which the straight portion 102 is deformed into the substantially S-shape due to a local increase in load in the slot 22 that can be caused by shifting of the position of the point of load.

The above condition D will be described with reference to FIG. 15. The term “comb tooth shoulder R” indicates a radius of a curved surface of a shoulder portion of the comb tooth 42 of the coil winding jig 4 around which the strip-shaped coil 100 is wound and held before the insertion into the slot 22. The shoulder portion of the comb tooth 42 is a shoulder portion located inside in a bending direction of the coil end portion 103. The coil end portions 103 expands in diameter also when the strip-shaped coil 100 moves toward the slots 22 while being guided by the comb teeth 42. Setting “guide shoulder R” to be equal to or less than “comb tooth shoulder R” makes it possible to reduce the inclination of the straight portion 102 of the strip-shaped coil 100 after the strip-shaped coil 100 comes into contact with the shoulder portions 331b of the guide portions 331 from the comb teeth 42 and transfers from the comb teeth 42 to the guide portions 331.

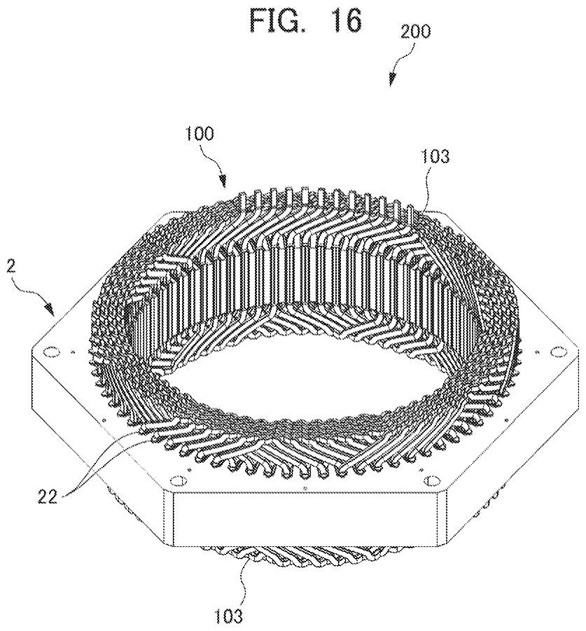

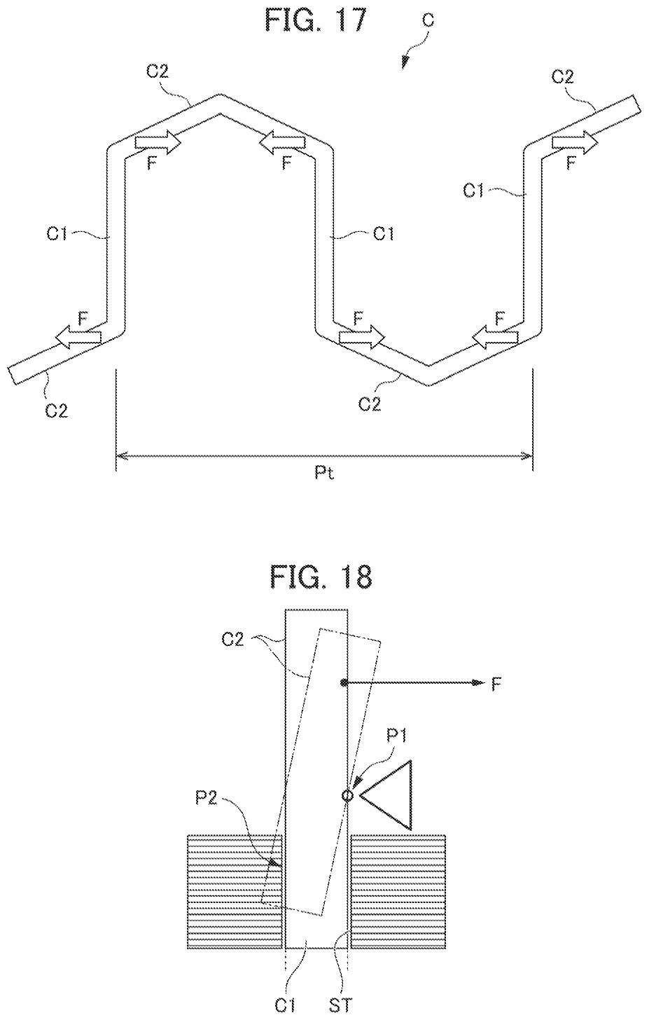

As described above, the coil insertion guide device 1 guides the strip-shaped coil 100 by means of the guide portions 331 so as to insert the coil 100 into the slots 22, whereby a stator 200 in which the strip-shaped coil 100 is mounted in the slots 22 is produced, as shown in FIG. 16.

The coil insertion guide device 1 according to the present embodiment provides the following effects. The coil insertion guide device 1 according to the present embodiment includes the plurality of guide portions 331 arranged over each of the axially opposite end faces 2a and 2a of the stator core 2 including the insulating papers 24 in the slots 22, and the guide portions 331 guide movement of the strip-shaped coil 100 that is insertable into the slots 22 along the radial direction of the stator core 2. The strip-shaped coil 100 includes the plurality of straight portions 102 insertable into the slot. 22 and the plurality of coil end portions 103 each connecting the adjacent straight portions 102 and 102 to each other among the plurality of straight portions 102. In each of the guide portions 331, the shoulder portion 3331b that comes into contact with the coil end portion 103 of the strip-shaped coil 100 has the convex curved surface that is continuous from the top 331c to the maximum width portion 331d. Due to this feature, each coil end portion 103 is gradually deformed to be inclined along the curved surface of the shoulder portion 331b of the guide portion 331 as the strip-shaped coil 100 moves in the slots 22, whereby the position of the contact portion CP between the strip-shaped coil 100 and the shoulder portion 331b of the guide portion 331 shifts. Therefore, when a point at which the reaction force F acts on the coil end portion 103 serves as the point of effort and the contact portion CP serves as the fulcrum, the position of the point of load at which the straight portion 102 of the strip-shaped coil 100 abuts on the inner wall surface of the slot 22 also shifts. Consequently, local application of the load to the straight portion 102 is avoided, and the substantially S-shaped deformation of the straight portion 102 is suppressed. As a result, the workability in mounting the strip-shaped coil 100 in the slots 22 improves.

In the present embodiment, each of the guide portions 331 has, in its portion facing the end face 2a of the stator core 2, the cuff portion-regulating groove portion 331a that accommodates and regulates the insulating paper 24 protruding from the end face 2a. The height of the cuff portion-regulating groove portion 331a is defined as “insulating member regulating height”, the radius of the curved surface of the corner portion formed between the cuff portion regulating groove portion 331a and the maximum width portion 331d of the guide portion 331 adjacent to the cuff portion regulating groove portion 331a is defined as “coil contact surface escape R”, the height, from the end face 2a of the stator core 2, of the region in which the guide portion 331 first comes into contact with the strip-shaped coil 100 is defined as “coil initial contact position”, the height, from the end face 2a of the stator core 2, of the boundary between the straight portion 102 and the coil end portion 103 of the strip-shaped coil 100 is defined as “coil R start point”, and it is preferable that the guide portion 331 satisfies condition A: “insulating member regulating height”+“coil contact surface escape R”≤“coil initial contact position”≤“coil R start point”. Setting “coil initial contact position” to be equal to or more than “insulating member regulating height”+“coil contact surface escape R” results in a decrease in the distance between the fulcrum and the point of effort, and makes it less likely for the straight portion 102 to be inclined. Setting “coil R start point” to be equal to or more than “coil initial contact position” further reduces the inclination of the straight portion 102 with the contact portion CP as the fulcrum. Thus, the guide portion 331 can more effectively suppress the substantially S-shaped deformation of the straight portion 102.

In the present embodiment, it is preferable that in the condition A, “coil R start point”≤“coil end shoulder R”. Due to this feature, the contact height of the guide portion 331 with the strip-shaped coil 100 can be kept low, and the effect of an excessive length of the straight portion 102 on the motor performance can be reduced.

In the present embodiment, it is preferable that the width of the strip-shaped coil 100 is defined as “coil width”, and the clearance between the adjacent guide portions 331 and 331 is defined as “guide CL”, and the guide portion 331 satisfies the condition B: “coil width”≤“guide CL”. Due to this feature, the damage to the coating of the strip-shaped coil 100 can be reduced while reducing the inclination of the straight portion 102.

In the present embodiment, it is preferable that the radius of the curved surface of the shoulder portion 331b of the guide portion 331 is defined as “the guide shoulder R”, and the bend radius of the root portion of the coil end portion 103 is defined as “coil end shoulder R”, and the guide portion 331 satisfies the condition C: “guide shoulder R” “coil end shoulder R”. Due to this feature, when the strip-shaped coil 100 comes into contact with the guide portion 331 and the strip-shaped coil 100 starts to be plastically deformed, the position of the contact portion CP serving as the fulcrum is likely to gradually move in the direction away from the end face 2a of the stator core 2. Thus, a situation is more effectively prevented or reduced in which the straight portion 102 is deformed into the substantially S-shape due to a local increase in load in the slot 22 that can be caused by shifting of the position of the point of load.

In the present embodiment, the coil insertion guide device 1 further includes the coil winding jig 4 including the comb teeth 42 around which the strip-shaped coil 100 is wound and held before insertion into the slot 22. It is preferable that the radius of the curved surface of the shoulder portion of the comb tooth 42 that comes into contact with the strip-shaped coil 100 is defined as “comb tooth shoulder R”, and the guide portion 331 satisfies the condition D: “guide shoulder R”≤“comb tooth shoulder R”. This feature makes it possible to reduce the inclination of the straight portions 102 of the strip-shaped coil 100 after the strip-shaped coil 100 comes into contact with the shoulder portions 331b of the guide portions 331 from the comb teeth 42 and transfers from the comb teeth 42 to the guide portions 331.

### EXPLANATION OF REFERENCE NUMERALS

1: Coil insertion guide device
2: Stator core
2a: End face
22: Slot
24: Insulating paper (Insulating member)
331: Guide portion
331a: Cuff portion-regulating groove portion (Regulating groove portion)
4: Coil winding jig
42: Comb tooth
100: Strip-shaped coil
102: Straight portion
103: Coil end portion

What is claimed is:

1. A coil insertion guide device comprising:
a plurality of guide portions arranged over each of end faces of a stator core that are opposite in an axial direction, the stator core including insulating members in slots, the guide portions being configured to guide movement of a strip-shaped coil that is insertable into the slots along a radial direction of the stator core,
wherein the strip-shaped coil includes a plurality of straight portions insertable into the slots and a plurality of coil end portions each connecting adjacent straight portions to each other among the plurality of straight portions, and
wherein in each of the guide portions, a shoulder portion that comes into contact with the coil end portion of the strip-shaped coil has a convex curved surface that is continuous from a top to a maximum width portion.

2. The coil insertion guide device according to claim 1,
wherein each of the guide portions has, in a portion facing the end face of the stator core, a regulating groove portion that accommodates and regulates the insulating member protruding from the end face, and
wherein a height of the regulating groove portion is defined as “insulating member regulating height”,
a radius of a curved surface of a corner portion formed between the regulating groove portion and the maximum width portion of the guide portion adjacent to the regulating groove portion is defined as “coil contact surface escape R”,
a height, from the end face of the stator core, of a region in which the guide portion first comes into contact with the strip-shaped coil is defined as “coil initial contact position”,
a height, from the end face of the stator core, of a boundary between the straight portion and the coil end portion of the strip-shaped coil is defined as “coil R start point”, and
the guide portion satisfies:
condition A: “insulating member regulating height”+“coil contact surface escape R”≤“coil initial contact position”≤“coil R start point”.

3. The coil insertion guide device according to claim 2,
wherein in the condition A, a bend radius of a root portion of the coil end portion is defined as “coil end shoulder R”, and “coil R start point”≤“coil end shoulder R”.

4. The coil insertion guide device according to claim 1,
wherein a width of the strip-shaped coil is defined as “coil width”,
a clearance between adjacent ones of the guide portions is defined as “guide CL”, and
the guide portion satisfies:
condition B: “coil width”≤“guide CL”.

5. The coil insertion guide device according to claim 1,
wherein a radius of a curved surface of the shoulder portion of the guide portion is defined as “guide shoulder R”,
a bend radius of a root portion of the coil end portion is defined as “coil end shoulder R”, and
the guide portion satisfies:
condition C: “guide shoulder R”≤“coil end shoulder R”.

6. The coil insertion guide device according to claim 1, further comprising:
a coil winding jig including comb teeth around which the strip-shaped coil is wound and held before insertion into the slots,
a radius of a curved surface of a shoulder portion of the comb tooth that comes into contact with the strip-shaped coil is defined as “comb tooth shoulder R”, and
the guide portion satisfies:
condition D: “guide shoulder R”≤“comb tooth shoulder R”.
